(19) United States
(12) Patent Application Publication
(10) Pub. No.: US 2026/0005517 A1
(43) Pub. Date: Jan. 1, 2026

(54) POWER CONVERSION APPARATUS WITH SINGLE BOOST CONVERTER CIRCUIT AND METHOD FOR OPERATING THE SAME

(71) Applicant: PNK HITECH CO., LTD., Incheon (KR)

(72) Inventor: In Guk PARK, Incheon (KR)

(21) Appl. No.: 18/786,639

(22) Filed: Jul. 29, 2024

(30) Foreign Application Priority Data
Jun. 28, 2024 (KR) 10-2024-0084933

(51) Int. Cl. H02J 3/38; H02J 3/00; H02M 1/10; H02M 1/42

(52) U.S. Cl. CPC H02J 3/38; H02J 3/007; H02M 1/10; H02M 1/4208; H02J 2300/26

(57) ABSTRACT

Disclosed is a power conversion apparatus including a single boost converter circuit and a method for operating the same, including: a power supply selection unit respectively connected to a direct current (DC) power supply and an alternating current (AC) power supply, and configured to connect the DC or AC power supply to a single boost converter circuit unit according to a power supply selection signal; a single boost converter circuit unit configured to apply a power factor correction method or a maximum power point tracking method according to a control selection signal applied in consideration of a type of input power supply connected through the power supply selection unit; and a control unit configured to generate the power supply selection signal and the control selection signal using at least one of DC sensing information associated with the DC power supply and AC sensing information associated with the AC power supply

### CROSS-REFERENCE TO RELATED APPLICATIONS

This application claims the priority of Korean Patent Application No. 10-2024-0084933 filed on Jun. 28, 2024, in the Korean Intellectual Property Office, the disclosure of which is incorporated herein by reference.

### BACKGROUND

### Field

The present disclosure relates to a power conversion apparatus having a single boost converter circuit and a method for operating the same. For example, the present disclosure relates to a high-efficiency energy storage device that controls solar power and power factor correction through a single boost converter.

### Description of the Related Art

Due to the recent increase in energy use around the world and environmental problems caused by the use of fossil fuels, new and renewable energy is evaluated as an eco-friendly and sustainable energy source that will replace the fossil fuels in the future, and many researches are being conducted under the leadership of technologically advanced countries.

In particular, solar energy is attracting attention by virtue of its many advantages such as unlimited energy, low maintenance costs, and ease of installation, etc., and thus research on such solar energy is actively underway. However, these solar light power generation systems also have disadvantages of being affected by weather conditions and installation locations and requiring for high installation costs. In particular, solar cells have a non-linear current-voltage characteristic curve or power-voltage characteristic curve, and their outputs vary depending on temperature or solar radiation intensity.

Because these solar light power generation systems have lower power generation efficiencies than other new and renewable energy sources, technologies to track the maximum power point according to the characteristics of solar cells are essential. Here, the technology that tracks the maximum power point according to changes in solar radiation intensity or temperature is referred to as a maximum power point tracking (MPPT) control. As MPPT control is of high importance in solar light power generation systems, many researches on the MPPT control have been conducted and various techniques have been proposed. The MPPT control techniques proposed so far have advantages and disadvantages depending on their performance principles.

Meanwhile, due to global warming issues, mandatory greenhouse gas reductions, rapid depletion of resources, instability in an energy market, and the like, the role of energy prosumers who produce and consume their own energy or eco-friendly energy that may replace nuclear power plants and fossil fuels is increasing. As energy consumption patterns shift from a supplier type to a consumer type, interest in distributed power generation centered on solar light power generation is increasing, and in order to solve charging issues due to the expansion of electric vehicles, interest in energy storage and supply systems centered on solar power are being raised.

In this regard, 221 companies around the world are participating in the voluntary campaign (RE100) to supply 100% of power required by companies with renewable energy, and as the number of participating companies gradually increases, the spread of solar energy is also expected to be expanded.

The background technology of the present disclosure is disclosed in Korean Patent Registration No. 10-2006808.

### SUMMARY

The present disclosure is directed to solving the problems of the related art described above, and an object to be achieved by the present disclosure is to provide a power conversion apparatus having a single boost converter circuit, in which a power factor correction circuit and a boost circuit are integrated into the single boost converter circuit, and high-efficiency performance may be maintained by selectively applying a power factor correction control manner and a maximum power point tracking control manner depending on a type of input power supply, and a method for operating the same.

However, technical problems to be solved in the embodiment of the present disclosure are not limited to the technical problems described above, and other technical problems may exist.

As technical means for achieving the aspect of the present disclosure, a power conversion apparatus including a single boost converter circuit according to one embodiment of the present disclosure may include a power supply selection unit that is connected to each of a direct current (DC) power supply and an alternating current (AC) power supply, and configured to connect the DC power supply or the AC power supply to a single boost converter circuit unit according to a power supply selection signal, a single boost converter circuit unit that is configured to apply a power factor correction (PFC) method or a maximum power point tracking (MPPT) method according to a control selection signal applied in consideration of a type of input power supply connected through the power supply selection unit, and a control unit that is configured to generate the power supply selection signal and the control selection signal using at least one of DC sensing information associated with the DC power supply and AC sensing information associated with the AC power supply.

In addition, the power conversion apparatus including the single boost converter circuit according to one embodiment of the present disclosure may include a DC-DC converter that is configured to convert a DC link voltage, which is an output voltage of the single boost converter circuit unit, into an output voltage of a preset output level, and a battery unit that is configured to store the converted output voltage.

Additionally, the DC power supply may include a photovoltaic (PV) power supply by solar light power generation.

Additionally, the DC sensing information may include at least one of sunlight information and weather information applied to a PV panel provided to generate PV power supply.

Additionally, the DC power supply may include a new and renewable energy-based power supply.

Additionally, a bridge diode circuit may be disposed between the AC power supply and the power supply selection unit.

In addition, the single boost converter circuit unit may include a switch element to which the control selection signal is applied and which is disposed between a reference node and a switch output node, an inductor element that is disposed between an input node connected to the power supply selection unit and the switch output node, and a diode element that is disposed between the switch output node and a boost output node, which is an output node of the single boost converter circuit unit.

Also, the single boost converter circuit unit may include a parallel configuration-type boost converter including the switch element, the inductor element, and the diode element, each of which is provided by two or more.

Also, the inductor elements of the parallel configuration-type boost converter may be disposed to connect the input node and the switch output nodes corresponding to the respective switch elements.

Meanwhile, a method for controlling a power conversion apparatus having a single boost converter circuit according to one embodiment of the present disclosure may include (a) acquiring direct current (DC) sensing information associated with a DC power supply and alternating current (AC) sensing information associated with an AC power supply, (b) generating a power supply selection signal for controlling the power supply selection unit, which is connected to each of the DC power supply and the AC power supply and is disposed to connect the DC power supply or the AC power supply to a single boost converter circuit unit, using at least one of the acquired DC sensing information and AC sensing information, and (c) generating a control selection signal for controlling the single boost converter circuit unit to apply a power factor correction (PFC) method or a maximum power point tracking (MPPT) method, by considering a type of input power supply connected through the power supply selection unit.

The solution to problem described above is merely illustrative and should not be construed as intended to limit the present disclosure. In addition to the exemplary embodiments described above, additional embodiments may be present in the drawings and detailed description of the disclosure.

According to the aspect of the present disclosure, there may be provided a power conversion apparatus having a single boost converter circuit, in which a power factor correction circuit and a boost circuit are integrated into the single boost converter circuit, and high-efficiency performance may be maintained by selectively applying a power factor correction method and a maximum power point tracking method depending on a type of input power supply, and a method for operating the same.

According to the solution to problem of the present disclosure, there may be implemented an energy storage device and a battery charging system capable of achieving minimization and cost reduction by simplifying a power factor correction circuit and a boost converter circuit into a single circuit, and allowing high-efficiency power conversion by performing power factor correction and maximum power point tracking according to input power supply.

According to the solution to problem of the present disclosure, there may be provided a power conversion apparatus that is applicable to various new and renewable energy-based power supplies, such as PV panels for solar light power generation and power conversion apparatuses for wind power generation, which output DC voltages.

However, the effects that may be obtained herein are not limited to the effects described above, and other effects may exist.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a block diagram of the related art energy storage device for an alternating current power supply;

FIG. 2 is a block diagram of the related art energy storage device equipped with a DC-DC converter based on solar light power generation;

FIG. 3 is an exemplary block diagram for adding a converter with a different input voltage or output voltage;

FIG. 4 is a schematic configuration diagram of an energy storage system including a power conversion apparatus having a single boost converter circuit according to one embodiment of the present disclosure;

FIG. 5 is a diagram illustrating that an energy storage system including a power conversion apparatus with a single boost converter circuit according to one embodiment of the present disclosure performs battery charging using a direct current power supply;

FIG. 6 is an exemplary diagram illustrating an energy storage system using a direct current power supply based on new and renewable energy;

FIGS. 7A-7B are exemplary diagrams illustrating the configuration of a power factor correction (PFC) circuit;

FIG. 8 is a detailed circuitry diagram of a single boost converter circuit unit of a single configuration type;

FIG. 9 is a detailed circuitry diagram of a single boost converter circuit unit of a parallel configuration type;

FIGS. 10A-10B are conceptual views illustrating a boost switching control method of a control unit; and

FIG. 11 is an operation flowchart of a method for controlling a power conversion apparatus including a single boost converter circuit according to one embodiment of the present disclosure.

### DETAILED DESCRIPTION OF THE EMBODIMENT

Hereinafter, an embodiment of the present disclosure will be described in detail, with reference to the accompanying drawings, so as to be easily embodied by those skilled in the art to which the present disclosure pertains. However, the present disclosure may be implemented in various different forms and is not limited to the embodiment described herein. In order to clearly explain the present disclosure in the drawings, parts that are not related to the description were omitted, and similar parts were given similar reference numerals throughout the specification.

Throughout the specification, when a part is said to be “connected” to another part, it includes not only cases where they are “directly connected,” but also cases where they are “electrically connected” or “indirectly connected” with another element interposed therebetween.

Throughout the specification, when a member is said to be located “on,” “above,” “at the top of,” “under,” “below,” or “at the bottom of,” another member, it includes a case where the member is located on the another member in contact with each other and a case where an intervening member is present between the two members.

Throughout the specification, when a part “includes” a component, it means that other components are further included, other than excluding the other components, unless otherwise specified.

The present disclosure relates to a power conversion apparatus having a single boost converter circuit and a method for operating the same. For example, the present disclosure relates to a high-efficiency energy storage device that controls solar power and power factor correction through a single boost converter.

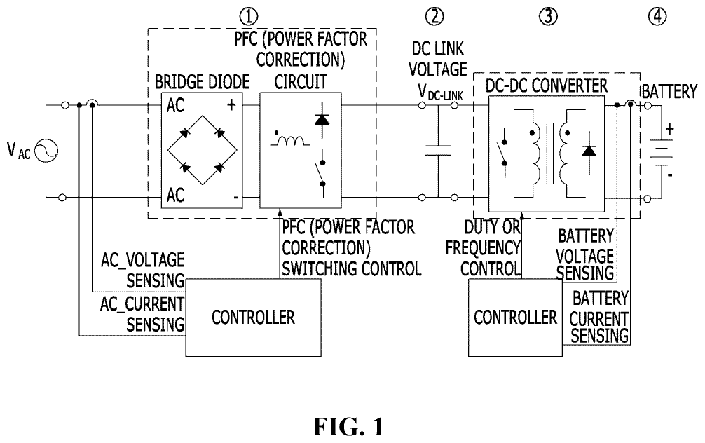

FIG. 1 is a block diagram of the related art energy storage device for an alternating current (AC) power supply.

Specifically, FIG. 1 is a circuitry diagram exemplarily illustrating a 12V DC energy storage device (battery charger). Referring to FIG. 1, the related art energy storage device, for example, may operate to charge a battery by converting 220V alternating current (AC) power into a 400V DC link voltage, and converting the converted 400V DC link voltage into 14.4V DC that is a 12V DC battery charging voltage.

In addition, as for the battery, lead acid batteries, lithium-ion batteries, lithium iron phosphate batteries, etc. may be used. 12V, 24V, 48V, etc. may be generally applied as a battery voltage, and for special specifications, the battery voltage may be determined variously in the range of about 12V to 96V, specifically, industrial or electric vehicle batteries have voltage specifications ranging from about 215V to 800V.

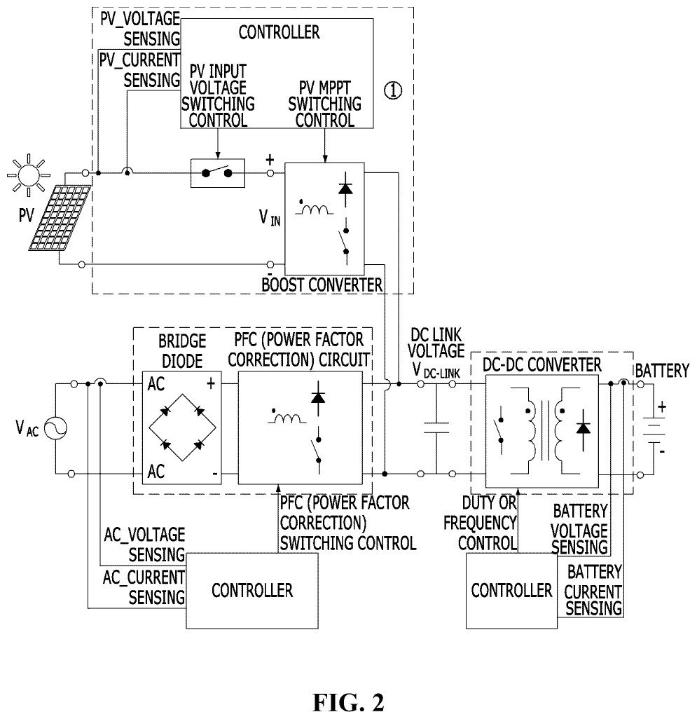

FIG. 2 is a block diagram of the related art energy storage device equipped with a DC-DC converter based on solar light power generation.

Specifically, referring to FIG. 2 that is a block diagram further including a circuit to charge a battery using a PV panel voltage (about 125 Vdc to 550 Vdc), the battery may be charged with the PV panel voltage by using the related art energy storage device including a DC-DC converter, and may be charged using an AC power supply in bad weather or at night. In particular, in order to convert the PV panel voltage into a DC link voltage, circuits such as a PV input voltage switch, a PV boost converter, etc. as illustrated in FIG. 2 are required, and a controller may be configured for each circuit, or all components may be controlled integrally by a single controller.

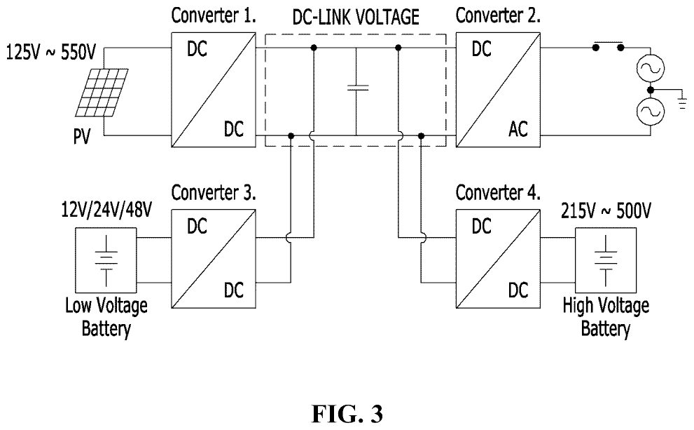

FIG. 3 is an exemplary block diagram for adding a converter with a different input voltage or output voltage.

Referring to FIG. 3, when a converter with a different input voltage or output voltage is added to a battery charging device, an energy storage device may be developed in a manner of adding a circuit that commonly uses a DC link voltage.

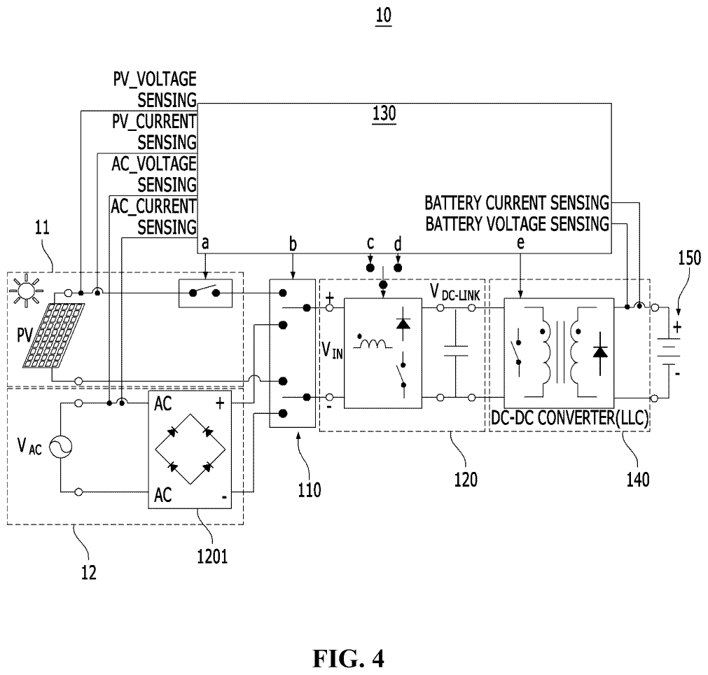

FIG. 4 is a schematic configuration diagram of an energy storage system including a power conversion apparatus having a single boost converter circuit according to one embodiment of the present disclosure.

Referring to FIG. 4, an energy storage system 10 according to one embodiment of the present disclosure may include a DC power supply 11, an AC power supply 12, a power conversion apparatus 100 provided with a single boost converter circuit according to one embodiment of the present disclosure (hereinafter, referred to as ‘power conversion apparatus 100’). In particular, the power conversion apparatus 100 disclosed herein may be an energy storage device designed to enable high-efficiency power conversion, which is the advantage of maximum power point tracking (MPPT) and power factor correction (PFC), by way of performing switching controls for selective application of the MPPT method or the PFC method depending on a type of input power supply while achieving miniaturization and cost reduction through simplification of a PFC circuit and a boost converter circuit into a single boost converter circuit.

By way of example, the energy storage system 10 disclosed herein may include a DC power supply 11 of a photovoltaic (PV) type power supply by solar light generation. The battery may be charged by using the DC power supply 11 when a solar light power generation amount of a PV panel satisfies a preset normal range. On the other hand, the battery may be charged by using the AC power supply 12 when the solar light power generation amount does not satisfy the preset normal range (for example, 10% or less of a rated capacity, etc.), such as when the weather is bad or during a night time.

Additionally, referring to FIG. 4, the power conversion apparatus 100 disclosed herein may include a power supply selection unit 110, a single boost converter circuit unit 120, a control unit 130, a DC-DC conversion unit 140, and a battery unit 150.

The power supply selection unit 110 may be connected to each of the DC power supply 11 and the AC power supply 12, and may be disposed to connect the DC power supply 11 or the AC power supply 12 to the single boost converter circuit unit 120 according to a power supply selection signal applied from the control unit 130.

Specifically, referring to FIG. 4, the power supply selection unit 110 may operate to switch input power supply from the DC power supply 11 according to a DC control signal (‘a’ in FIG. 4) applied from the control unit 130. In addition, referring to FIG. 4, the power supply selection unit 110 may determine power supply applied from the DC power supply 11 or the AC power supply 12 to the single boost converter circuit unit 120 according to a power supply selection signal (‘b’ in FIG. 4) applied from the control unit 130. In this regard, the power supply selection unit 110 may be provided in the form of a power relay circuit that may be interconnected to each of the DC power supply 11 and the AC power supply 12 through switching using a power supply selection signal, but is not limited thereto.

In the description of the embodiment of the present disclosure, the DC power supply 11 may include a power supply based on new and renewable energy such as photovoltaics (PV) power supply generated by solar light generation or wind power, but is not limited thereto.

Meanwhile, referring to FIG. 4, a bridge diode circuit 1201 may be disposed between the AC power supply 12 and the power supply selection unit 110.

The single boost converter circuit unit 120 may be configured to apply power factor correction (PFC) method or maximum power point tracking (MPPT) method according to a control selection signal applied from the control unit 130 in consideration of a type of input power supply connected through the power supply selection unit 110.

Specifically, referring to FIG. 4, the single boost converter circuit unit 120 may be controlled to operate in the power factor correction (PFC) method or the maximum power point tracking (MPPT) method depending on a control selection signal (‘c’ and ‘d’in FIG. 4) applied from the control unit 130.

Meanwhile, in FIG. 4, the single boost converter circuit unit 120 is shown as being provided as a single set, but is not limited to this. The single boost converter circuit unit 120 may alternatively be provided by a plurality of sets according to an implementation of the present disclosure.

Additionally, referring to FIG. 4, the single boost converter circuit unit 120 may include a condenser circuit that outputs a DC link voltage. For example, 400 VDC may be applied as a DC link voltage, but is not limited thereto, and a fixed voltage in the range of 370 VDC to 400 VDC may be applied according to an example of the present disclosure.

The control unit 130 may generate a power supply selection signal and a control selection signal using at least one of DC sensing information associated with the DC power supply 11 and AC sensing information associated with the AC power supply 12.

Specifically, when voltage sensing information or current sensing information of the DC power supply 11 is less than a preset reference value based on the DC sensing information, the control unit 130 may generate a power supply selection signal to select the AC power supply 12 as an input power supply, and generate a control selection signal for applying the PFC switching control to correspond to the AC power supply 12.

Conversely, when voltage sensing information or current sensing information of the DC power supply 11 is equal to or greater than the preset reference value based on the DC sensing information, the control unit 130 may generate a power supply selection signal to select the DC power supply 11 as an input power supply, and generate a control selection signal for applying the MPPT switching control to correspond to the DC power supply 12.

As another example, in case where the DC power supply 11 is a PV type power supply, the control unit 130 may generate a power supply selection signal to select the AC power supply 12 as an input power supply and generate a control selection signal for applying the PFC switching control to correspond to the AC power supply 12 when it is expected based on the DC sensing information that an amount of sunlight applied to the PV panel is below a reference level or a power generation amount in the PV panel is less than a reference value in consideration of weather information.

Conversely, the control unit 130 may generate a power supply selection signal to select the DC power supply 12 as an input power supply and generate a control selection signal for applying the MPPT switching control to correspond to the DC power supply 12 when it is expected based on the DC sensing information that the amount of sunlight applied to the PV panel is equal to or greater than the reference level or the power generation amount of the PV panel is equal to or greater than the reference value to be sufficient in consideration of weather information.

Additionally, referring to FIG. 4, the control unit 130 may generate a converter control signal (‘e’ in FIG. 4) to perform duty control or frequency control for the DC-DC conversion unit 140, and control the DC-DC conversion unit 140 using the generated converter control signal.

Meanwhile, FIG. 4 illustrates that the control unit 130 generates control signals for each of the power supply selection unit 110, the single boost converter circuit unit 120, and the DC-DC conversion unit 140, respectively, to perform integrated control for such respective sub-modules. However, it may be of course that control modules may be provided independently for the power supply selection unit 110, the single boost converter circuit unit 120, and the DC-DC conversion unit 140.

By way of example, the DC sensing information associated with the DC power supply 11 may include at least one of sunlight information and weather information that are applied to the PV panel, which is disposed to generate PV power supply, in relation to the DC power supply 11 of the photovoltaics (PV) type power supply.

Additionally, referring to FIG. 4, the DC sensing information transmitted to the control unit 130 may include voltage sensing information and current sensing information associated with the DC power supply 11, and the AC sensing information transmitted to the control unit 130 may similarly include voltage sensing information and current sensing information associated with the AC power supply 12.

The DC-DC conversion unit 140 may convert a DC link voltage, which is an output voltage of the single boost converter circuit unit 120, into an output voltage of a preset output level. Specifically, the DC-DC conversion unit 140 may be controlled to convert the DC link voltage into a battery charging voltage and charge the battery unit 150 with a constant voltage (CV), a constant current, a constant current-constant voltage, or the like. Additionally, the specifications of components constituting the DC-DC conversion unit 140 may be variably applied depending on a charging voltage according to the voltage specification of the battery unit 150.

The battery unit 150 may be configured to store an output voltage converted by the DC-DC conversion unit 140.

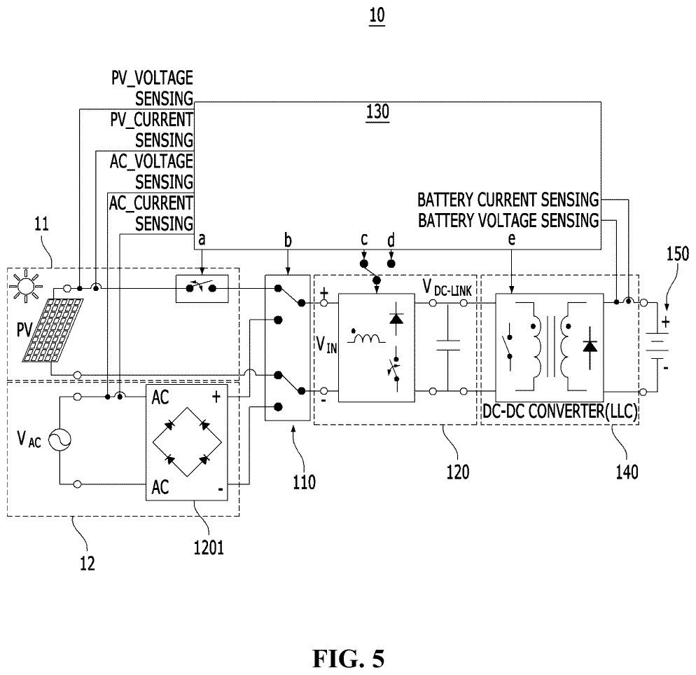

FIG. 5 is a diagram illustrating that an energy storage system including a power conversion apparatus with a single boost converter circuit according to one embodiment of the present disclosure performs battery charging using a DC power supply.

Referring to FIG. 5, when obtaining DC sensing information indicating that a solar light generation amount of the PV panel is normal, the control unit 130 may apply a power supply selection signal and a control selection signal for applying PV input switching and PV MPPT switching controls to be suitable for the generated power of the PV panel on the side of the DC power supply 11. Accordingly, the maximum power point tracking (MPPT) control that is a technique to track the maximum power point according to the characteristics of solar cells during solar light generation may be applied, thereby improving efficiency of the PV power conversion. On the other hand, if the solar light power generation amount of the PV panel is insufficient or power is not generated at night, the PFC switching control may be applied after changing an input power supply such that the battery unit 150 is charged by using the AC power supply 12 when necessary, thereby converting power with high efficiency even in a circuit that operates as a PV boost converter.

Specifically, the maximum power point tracking (MPPT) control method is a control algorithm applied to generate better power output from turbines and PV solar modules in various circumstances. This MPPT control may refer to a method of controlling the energy storage system 10 to charge the battery unit 150 with the maximum power output by sensing a generated voltage of the solar cell panel (PV panel) in real time and tracking a maximum voltage value and a maximum current value.

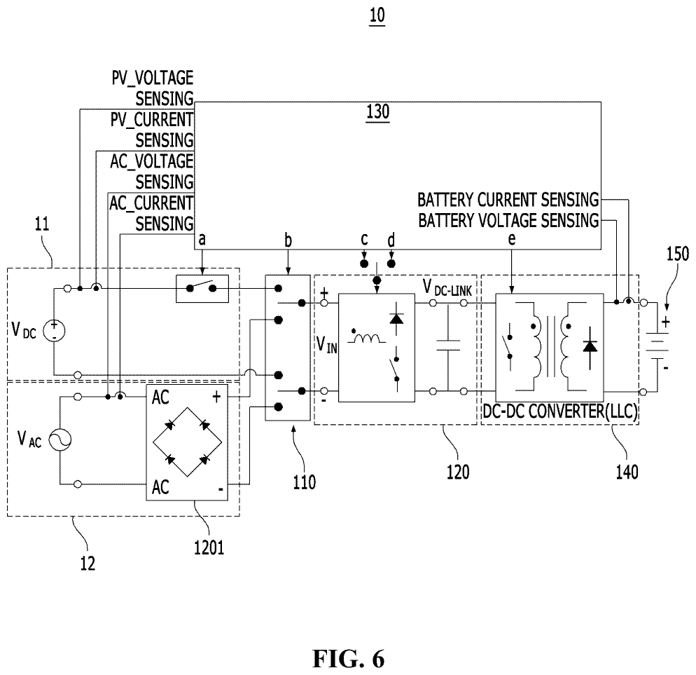

FIG. 6 is an exemplary diagram illustrating an energy storage system using a new and renewable energy-based DC power supply.

Referring to FIG. 6, the energy storage system 10 disclosed herein is not limited to receiving DC power from the PV panel, as illustrated in FIGS. 4 and 5, but may perform power conversion and energy storage by utilizing a new and renewable energy-based DC power supply 11, such as a power conversion apparatus for wind power generation or the like, which outputs various DC voltages.

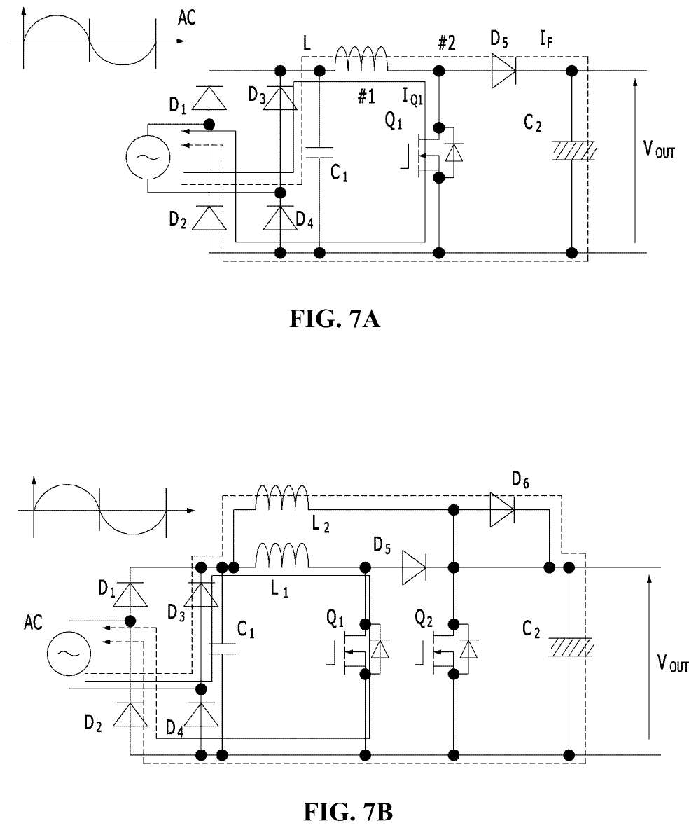

FIGS. 7A-7B are exemplary diagrams illustrating the configuration of a power factor correction (PFC) circuit. Specifically, FIG. 7A illustrates a PFC circuit (single type) configured as one set, and FIG. 7B illustrates a PFC circuit (interleaved type) configured as two sets in parallel.

Referring to FIGS. 7A-7B, in relation to the power factor correction (PFC) method, as a power supply selection signal for selecting the AC power supply 12 and a control selection signal for applying the PFC method are applied from the control unit 130, the single boost converter circuit unit 120 may convert an AC input voltage (e.g., an input voltage in the range of 90 VAC to 260 VAC) from the AC power supply 12 into a DC link voltage (e.g., a voltage of 400 VDC) through a PFC circuit, and convert the converted DC link voltage into a battery charging voltage through the DC-DC conversion unit 140, to perform charging of the battery unit 150.

Meanwhile, PFC circuits may be divided into active PFC and passive PFC, and the active PFC may have relatively high efficiency, and may operate in a manner of maximizing efficiency after boosting an AC input voltage to a DC link voltage.

In addition, PFC circuits may be divided into a single type configured as one set of switching element, diode, and inductor, and an interleaved type configured as two sets. In this case, the switching element may widely include power transistor components such as SiC modules, MOSFETs, and transistors.

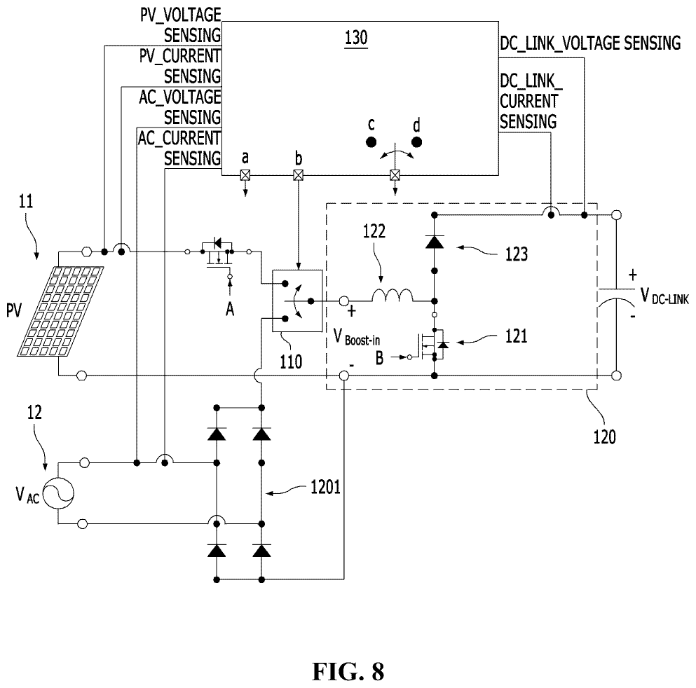

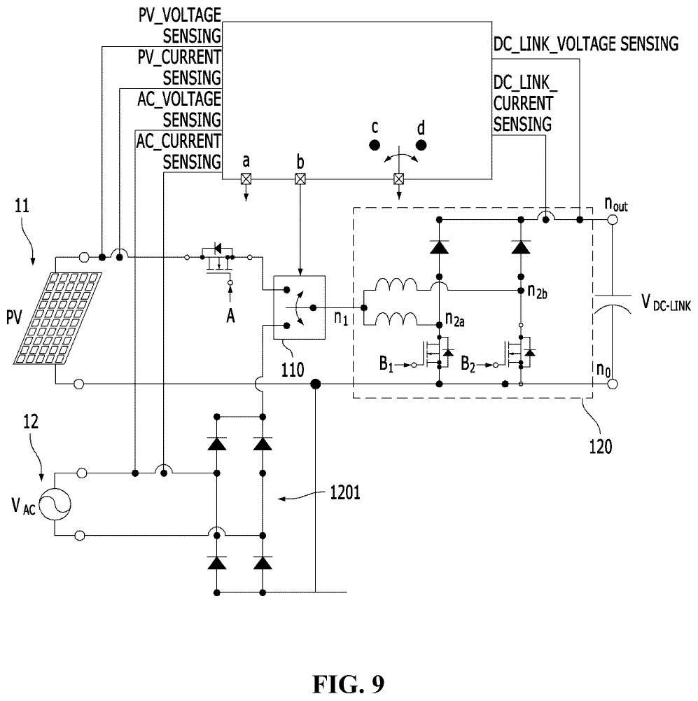

Hereinafter, a detailed circuit structure and operating method of the single boost converter circuit unit 120 will be described with reference to FIGS. 8 and 9.

FIG. 8 is a detailed circuitry diagram of a single boost converter circuit unit with a single configuration.

Referring to FIG. 8, the single boost converter circuit unit 120 may include a switch element 121 to which a control selection signal (see ‘B’in FIG. 8) transmitted from the control unit 130 is applied and which is disposed between a reference node n₀ and a switch output node n₂, an inductor element 122 that is disposed between an input node n₁ connected to the power supply selection unit 110 and the switch output node n₂, and a diode element 123 that is disposed between the switch output node n₂ and a boost output node nₒᵤₜ as an output node of the single boost converter circuit unit 120.

FIG. 9 is a detailed circuitry diagram of a single boost converter circuit unit with a parallel configuration.

Referring to FIG. 9, the power conversion apparatus 100 disclosed herein may include a parallel configuration-type boost converter including switch elements 121, inductor elements 122, and diode elements 123, each of which are provided by two or more. Specifically, FIG. 9 illustrates a parallel configuration-type single boost converter circuit unit 120 including a pair of switch elements 121, a pair of inductor elements 122, and a pair of diode elements 123.

In addition, referring to FIG. 9, the inductor elements 122 included in the parallel configuration-type single boost converter circuit unit 120 may be disposed to connect the input node n₁ and switch output nodes n₂ₐ and n_{2b} corresponding to the respective switch elements 121. In other words, in the case of the parallel configuration-type single boost converter circuit unit 120 illustrated in FIG. 9, one of the pair of inductor elements 122 may be disposed between the input node n₁ and the output node n₂ₐ of the first switch element 121, and the other of the pair of inductor elements 122 may be disposed between the input node n₁ and the output node n_{2b} of the second switch element 121.

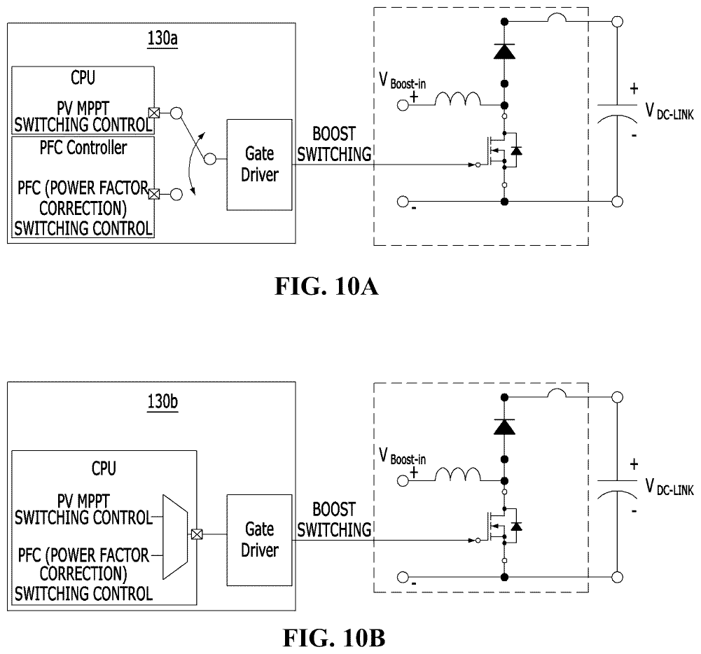

FIGS. 10A-10B are conceptual views illustrating a boost switching control method of a control unit. Specifically, FIG. 10A is a conceptual diagram illustrating a boost switching control method in which the control unit 130 switches in hardware a control selection signal applied to the switch element 121 disposed in the single boost converter circuit unit 120, and FIG. 10B is a conceptual diagram illustrating a boost switching control method in which the control unit 130 switches in software the control selection signal applied to the switch element 121 disposed in the single boost converter circuit unit 120.

Referring to FIG. 10A, for example, the control unit 130a, which operates in hardware, may independently include a central processing unit (CPU) for MPPT switching control, and a PFC controller for PFC switching control, and may apply boost switching by connecting each component to a gate driver.

In addition, referring to FIG. 10B, a control unit 130b operating in software, for example, may include a central processing unit (CPU) having a logic element that selectively applies MPPT switching control or PFC switching control, and a gate driver that transmits a control signal applied from the CPU to the single boost converter circuit unit 120.

Meanwhile, the CPU illustrated in FIGS. 10A-10B may include various types of processors, such as a micro controller unit (MCU), a microcontroller, a digital signal processor (DSP), a field programmable gate array (FPGA), etc., which have been already known or may be developed in the future, in addition to the central processing unit (CPU).

Further, according to one embodiment of the present disclosure, the control unit 130 may also include a circuit, which includes a dedicated controller IC such as a PFC controller and an MPPT Controller, a clock generator, a timer, etc., according to an example of the present disclosure.

Hereinafter, the operation flow of the present disclosure will be briefly described based on the details described above.

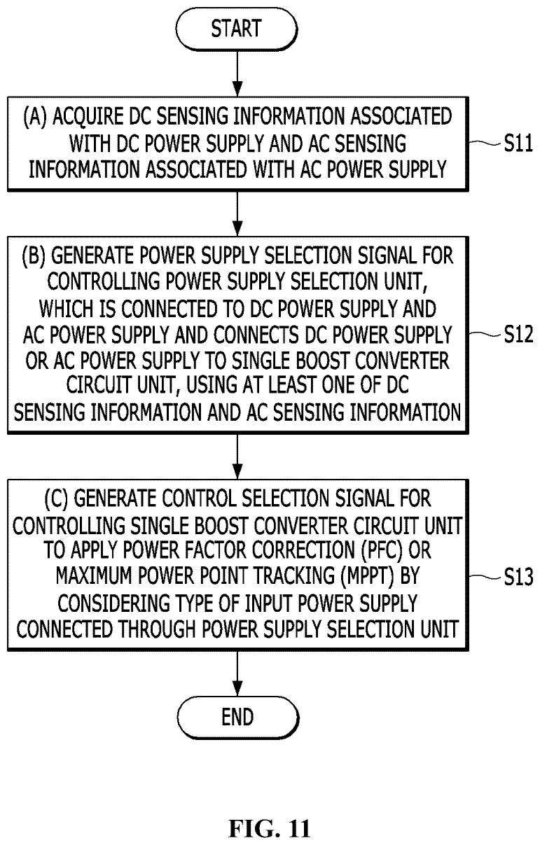

FIG. 11 is an operation flowchart illustrating a method for controlling a power conversion apparatus including a single boost converter circuit according to one embodiment of the present disclosure.

A method for controlling a power conversion apparatus including a single boost converter circuit illustrated in FIG. 11 may be performed by the power conversion apparatus 100 described above. Therefore, even if a content is omitted below, the content described with respect to the power conversion apparatus 100 will be equally applied to the description of the method for controlling the power conversion apparatus including the single boost converter circuit.

Referring to FIG. 11, in step S11, the control unit 130 may acquire DC sensing information associated with the DC power supply 11 and AC sensing information associated with the AC power supply 12 (a).

Next, in step S12, the control unit 130 may generate a power supply selection signal for controlling the power supply selection unit 110, which is connected to each of the DC power supply 11 and the AC power supply 12 and is disposed to connect the DC power supply 11 or the AC power supply 12 to the single boost converter circuit unit 120, using at least one of the acquired DC sensing information and AC sensing information (b).

Next, in step S13, the control unit 130 may generate a control selection signal for controlling the single boost converter circuit unit 120 to apply the Power factor correction (PFC) method or the Maximum power point tracking (MPPT) method, by considering a type of input power supply connected through the power supply selection unit 110 (c).

In the above description, the steps S11 to S13 may be further divided into additional steps or combined into fewer steps, depending on the example of the present disclosure. Additionally, some steps may be omitted or the order of steps may change as needed.

The method for controlling the power conversion apparatus including the single boost converter circuit according to one embodiment of the present disclosure may be implemented in the form of program instructions that may be executed through various computer means and recorded on a computer-readable medium. The computer-readable medium may include program instructions, data files, data structures, etc., individually or in combination. The program instructions recorded in the medium may be especially designed and configured for the present disclosure, or may be known to those skilled in the art of computer software for use. Examples of such computer-readable recording media may include magnetic media such as hard disk, floppy disk, and magnetic tape, optical media such as CD-ROM and DVD, magneto-optical media such as floptical disk, and hardware devices such as ROM, RAM, flash memory, etc., which are specifically configured to store and execute program instructions. Examples of such program instructions include not only machine language codes created by a compiler, for example, but also high-level language codes executable by a computer using an interpreter or the like. The hardware devices described above may be configured to operate as one or more software modules to perform the operations of the present disclosure, and vice versa.

Additionally, the method for controlling the power conversion apparatus including the single boost converter circuit described above may also be implemented in the form of a computer program or application executed by a computer stored in the recording medium.

The description of the present disclosure described above is for illustrative purposes only, and it will be understood by those skilled in the art to which the present disclosure pertains that the present disclosure may be easily modified into other specific forms without changing technical concept or essential features of the present disclosure. Therefore, it should be understood that the above-described exemplary embodiments are illustrative in all aspects and do not limit the present disclosure. For example, each component described as a singular form may be implemented in a distributed manner, and similarly, components described as distributed may also be implemented in a combined form.

The scope of the present disclosure is determined by the claims to be described later rather than the detailed description above. All changes or modifications derived from the meaning and scope of the claims and their equivalent concepts should be construed as being included in the scope of the present disclosure.

1. A power conversion apparatus having a single boost converter circuit, the power conversion apparatus comprising:
a power supply selection unit, including a power relay circuit, connected to a direct current (DC) power supply and an alternating current (AC) power supply and configured to connect the DC power supply or the AC power supply to the single boost converter circuit according to a power supply selection signal;
the single boost converter circuit configured to apply a power factor correction (PFC) method or a maximum power point tracking (MPPT) method according to a control selection signal, wherein the control selection signal is generated based on whether input power supply to the single boost converter circuit connected through the power supply selection unit is DC or AC; and
a controller configured to generate the power supply selection signal and the control selection signal using at least one of DC sensing information associated with the DC power supply and AC sensing information associated with the AC power supply,
wherein the single boost converter circuit includes a parallel configuration-type single boost converter circuit including two or more switches, two or more inductors, and two or more diodes, and
wherein each of the two or more inductors is connected between an input node and a switch output node corresponding to a respective one of the two or more switches.

2. The power conversion apparatus of claim 1, further comprising:
a DC-DC converter configured to convert a DC link voltage into an output voltage of a preset output level, wherein the DC link voltage is an output voltage of the single boost converter circuit; and
a battery configured to store the converted output voltage.

3. The power conversion apparatus of claim 1, wherein the DC power supply comprises a photovoltaic (PV) power supply by solar light power generation.

4. The power conversion apparatus of claim 3, wherein the DC sensing information comprises at least one of sunlight information and weather information applied to a PV panel configured to generate the PV power supply.

5. The power conversion apparatus of claim 1, wherein the DC power supply comprises a renewable energy-based power supply.

6. The power conversion apparatus of claim 1, wherein a bridge diode circuit is disposed between the AC power supply and the power supply selection unit.

7. The power conversion apparatus of claim 1, wherein:
each of the two or more switches is disposed between a reference node and the switch output node and configured to receive the control selection signal;
each of the two or more inductors is disposed between the input node connected to the power supply selection unit and the switch output node; and
each of the two or more diodes is disposed between the switch output node and a boost output node of the single boost converter circuit.

8. (canceled)

9. A method for controlling a power conversion apparatus having a single boost converter circuit, the method comprising:
acquiring direct current (DC) sensing information associated with a DC power supply and alternating current (AC) sensing information associated with an AC power supply;
generating a power supply selection signal for controlling a power supply selection unit, including a power relay circuit, connected to each of the DC power supply and the AC power supply and configured to connect the DC power supply or the AC power supply to the single boost converter circuit, using at least one of the DC sensing information and the AC sensing information; and
generating a control selection signal for controlling the single boost converter circuit to selectively apply a power factor correction (PFC) method or a maximum power point tracking (MPPT) method, based on whether input power supply to the single boost converter circuit connected through the power supply selection unit is DC or AC.
wherein the single boost converter circuit includes a parallel configuration-type single boost converter circuit including two or more switches, two or more inductors, and two or more diodes, and
wherein each of the two mor more inductors is connected between an input node and a switch output node corresponding to a respective one of the two or more switches.

10. The method of claim 9, wherein the DC power supply comprises a photovoltaic (PV) power supply by solar light power generation or a renewable energy-based power supply.

11. The method of claim 10, wherein the DC sensing information comprises at least one of sunlight information and weather information applied to a PV panel configured to generate the PV power supply.

12. The method of claim 9, wherein the single boost converter circuit comprises:
each of the two or more switches is disposed between a reference node and the switch output node and configured to receive the control selection signal;
each of the two or more inductors is disposed between the input node connected to the power supply selection unit and the switch output node; and
each of the two or more diodes is disposed between the switch output node and a boost output node of the single boost converter circuit.
